(19) United States
(12) Patent Application Publication
(10) Pub. No.: US 2019/0227583 A1
(43) Pub. Date: Jul. 25, 2019

(54) THERMOSTATIC CARTRIDGE

(71) Applicant: VERNET, Ollainville (FR)

(72) Inventors: Frédéric JAGER, Saint-Cheron (FR); Samuel MARQUIER, Fleury Merogis (FR)

(21) Appl. No.: 16/330,348

(22) PCT Filed: Sep. 5, 2017
(86) PCT No.: PCT/EP2017/072180

§ 371 Date: Mar. 4, 2019

(30) Foreign Application Priority Data
Sep. 5, 2016 (FR) 1658217

(51) Int. Cl. G05D 23/13; F16K 31/00

(52) U.S. Cl. CPC G05D 23/1346; F16K 31/002

(57) ABSTRACT

This thermostatic cartridge (1) has a hollow casing (10); a thermostatic element (30); a return spring (40); a slide valve (20) which is movably mounted inside a chamber (11) of the casing to regulate the respective amounts of cold fluid (F) and hot fluid (C) entering the chamber, and which is axially translatably coupled to a thermosensitive portion (31) of the thermostatic element; an end piece (50) against which a portion (32) of the thermostatic element, axially translatably actuated by the thermosensitive portion, is axially pressed under the action of the return spring; a nut (60), axially translatably mounted inside the chamber while being rotatably linked to the casing; an overtravel spring (70), axially inserted between the end piece and the nut in order to rigidly connect the end piece and the nut axially, as long as the slide valve can be freely moved axially by the r thermosensitive portion; and a screw (80), which is screwed into the nut while being locked against axial translation relative to the casing and which extends from inside the chamber to the outside of the casing via a bore (18) in the casing. The screw has a threaded portion (81) which is screwed inside the nut, and a first screw seat (83) disposed in the bore and which, inside the bore, is guided relative to the casing in order to align the screw with the axis. To limit the clearance of the screw, the latter further includes a second seat (84), which is separate from the threaded portion and the first seat, and which is arranged inside the chamber but outside the bore, the second seat being guided inside the chamber and relative to the casing such that the screw is aligned with the axis.

The present invention relates to a thermostatic cartridge.

The invention in particular applies to the sanitary field, and thus examines mixer taps, for a sink and a shower for example, which make it possible to “mix”, i.e., to combine an incoming stream of cold water and an incoming stream of hot water to form a single stream of outgoing water, called “mixed water”, having a temperature midway between the respective temperatures of the hot water and the cold water.

Such mixers are said to be thermostatic when they make it possible to set the temperature of the mixed water to a substantially constant and adjustable value, independently of the respective pressures and temperatures of the cold water and the hot water, and the flow rate of the mixed water, in a certain pressure and flow rate range. This thermostatic function is performed by ad hoc means that are arranged essentially inside a hollow casing, thus forming a preassembled assembly that is described as “thermostatic cartridge” and that is placed in one piece inside the tubular outer body of a mixer tap. An example of such a thermostatic cartridge is given in FR 2,774,740.

Thus, the aforementioned thermostatic means comprise a slide valve for setting quantities of cold water and hot water, the movements of which inside the casing are controlled by a first part of a thermostatic element, provided to be heat-sensitive and placed on the stream of mixed water. The second part of the thermostatic element, relative to which the first part is translated along the central axis of the casing during the heating of said first part, is pressed against a mechanism for adjusting the axial position of said second part: by maneuvering said mechanism from the outside of the casing, the user modifies the axial position of the second part of the thermostatic element and, from there, the temperature to which the slide valve sets the cold water and hot water inlets, in other words, the temperature of the mixed water. This mechanism includes a maneuvering screw, which extends from the inside to the outside of the casing via a bore of the casing and is, inside the casing, screwed into a nut rotatably connected to the casing. The screwing, respectively unscrewing, of the screw leads to translating the nut in one direction, respectively the opposite direction, and driving, in a corresponding manner, an end piece movable inside the casing, against which the second part of the thermostatic element is pressed axially. To allow an overtravel of the thermostatic element, i.e., a relative axial separation of its first and second parts such as the axial movement of the setting slide valve by the first part relative to the casing is prevented due to the axial bearing of said slide valve against a fixed inner stop of the casing, an overtravel spring is typically axially inserted between the end piece and the nut: this spring is provided rigid enough so that, as long as the slide valve can be freely moved axially by the first part of the thermostatic element, the spring axially rigidly connects the end piece and the nut.

This adjusting mechanism is satisfactory when the cartridge is in use, in particular when it is supplied with cold water and hot water. Conversely, before it is connected to incoming streams of cold water and hot water, in other words before the hydraulic pressurization of the inside of the casing of said cartridge, the screw of its aforementioned adjusting mechanism has a certain clearance freedom with respect to the casing, while being able to be freely tilted by several degrees relative to the central axis of the casing, by tilting at the part of said screw arranged in the aforementioned bore of the casing. This possibility of free clearance of the screw originates in the radial play between the components of the mechanism and the casing of the cartridge, said radial play being necessary for the assembly of the cartridge and its later proper operation. In particular, in FR 2,774,740 mentioned previously, the screw is only guided relative to the casing, so as to align the screw on the axis, by a single screw seat of the screw, said screw seat being arranged inside the aforementioned bore, with radial interposition of sealing gaskets; thus, inside the chamber, the screw is, over the entire expanse of the latter, radially distant from the wall of the chamber, including at a flange ring of the screw allowing the axial bearing of the latter against an inner shoulder of the chamber, free play remaining radially between said flange ring and the wall of the chamber.

Although this possibility of free clearance of the screw has no impact on the performance of the cartridge once the latter is placed under hydraulic pressure, it is felt negatively by customers handling the cartridge before the latter is commissioned: indeed, these customers have the impression that the adjusting mechanism is poorly assembled or damaged. Even after hydraulic pressurization of the cartridge, the screw retains a certain clearance amplitude, which may be felt as a defect by the users.

The aim of the present invention is to improve the existing cartridges to limit the clearance of the screw of its adjusting mechanism, while retaining a simple assembly and standard sizing for the cartridge.

To that end, the invention relates to a thermostatic cartridge, as defined in claim 1.

Thus, to reinforce the alignment of the screw on the axis of the chamber, the invention proposes to guide the screw relative to the casing both in line with the bore through which the screw extends from the inside to the outside of the casing, and inside the chamber. To that end, the invention provides that the screw includes at least two screw seats for alignment on the axis of the chamber, a first screw seat corresponding to the part of the screw arranged in the aforementioned bore, while the second screw seat is arranged inside the chamber, while being separate from the first screw seat and the threaded part of the screw, arranged inside the nut. In this way, the screw is guided relative to the casing in two separate screw seats, in particular axially distant from one another: one thus jointly obtains long guiding, compared to the short guiding done only at the bore. The amplitude of the tilting of the screw relative to the casing is very greatly reduced, or even nil.

In practice, several embodiments can be considered to perform the guiding of the second screw seat of the screw. According to a first embodiment, this guiding is not done directly against the casing, but through the end piece and the nut of the cartridge, as explained in more detail hereinafter: this approach makes it possible to carry out the invention without adding any additional component to the cartridge, only the screw and the end piece being suitable for cooperating directly with one another. According to a second embodiment, this guiding is done directly between the second screw seat of the screw and a wall of the casing, delimiting the chamber of the latter, subject to the insertion between said second screw seat and said wall of a simple compensating gasket for radial play between them. In both cases, neither the assembly nor the total axial dimension of the cartridge according to the invention are significantly affected, compared with a pre-existing cartridge. Thus, in all cases, the invention goes against the prejudice according to which it would be necessary to reduce all of the assembly play between the various components of the cartridge to have a significant impact on the amplitude of the clearance of the screw relative to the casing, such a reduction of all of the play leading to major assembly constraints and/or over-dimensioning of the various contact interfaces between the components.

Additional advantageous features of the thermostatic cartridge according to the invention are specified in the dependent claims.

The invention will be better understood upon reading the following description, provided solely as an example and done in reference to the drawings, in which:

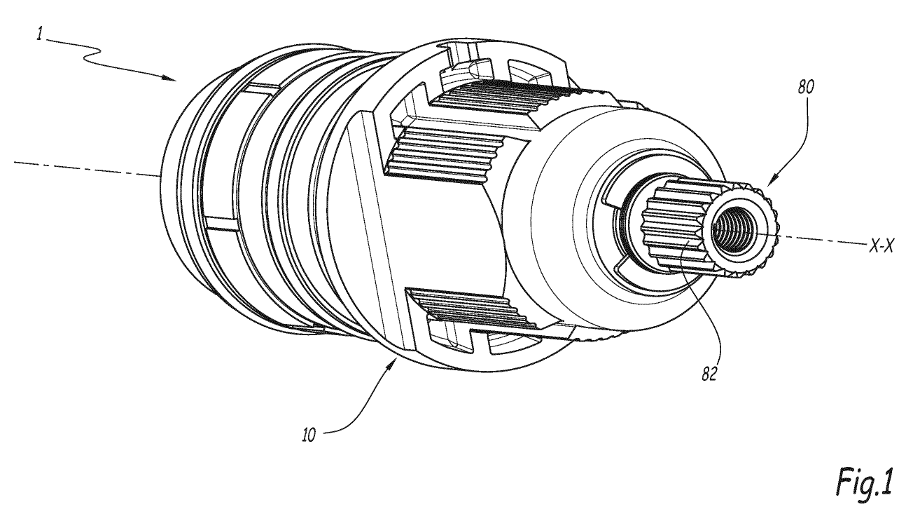

FIG. 1 is a perspective view of a first embodiment of a cartridge according to the invention;

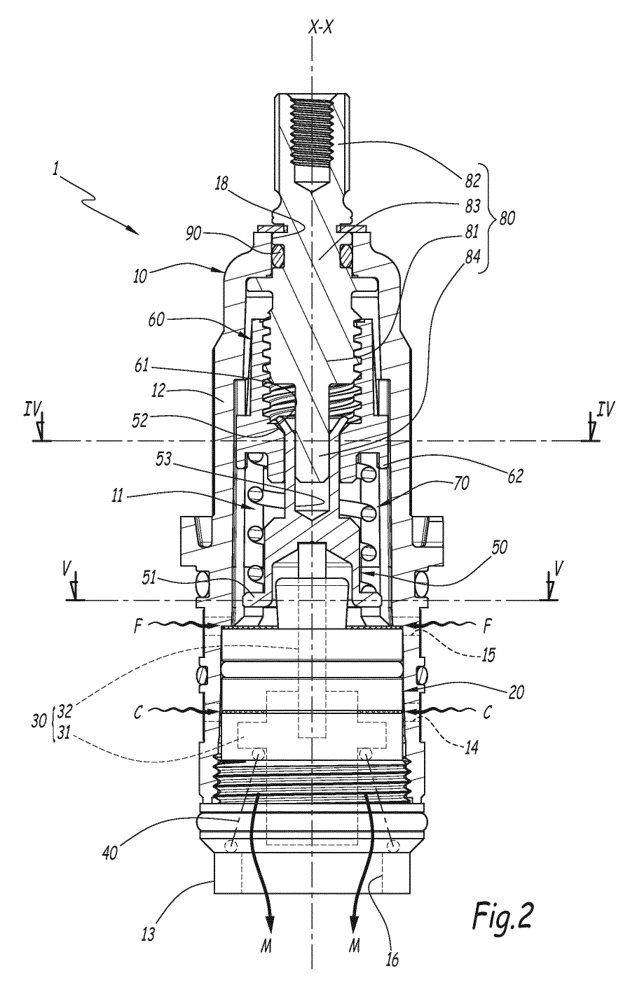

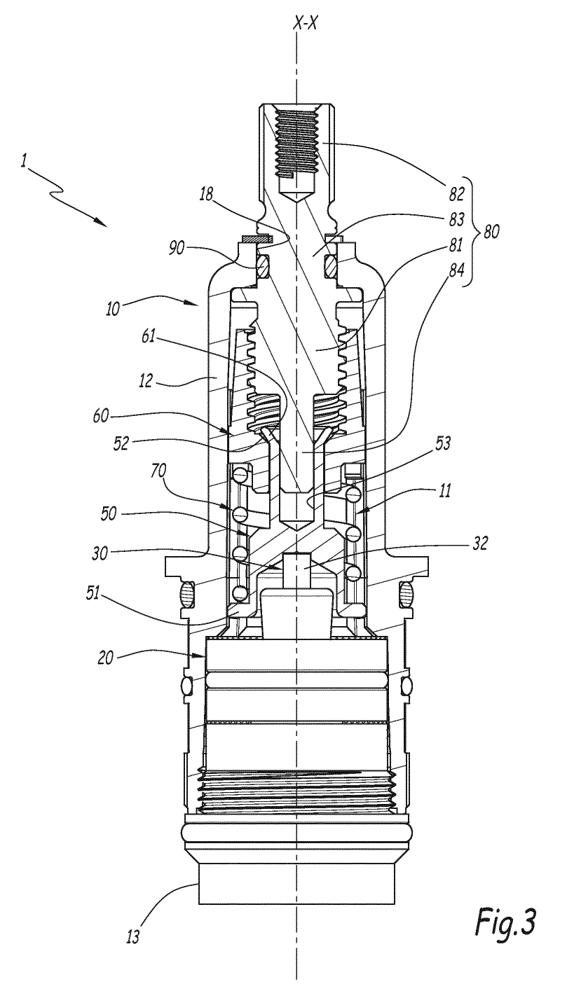

FIGS. 2 and 3 are longitudinal sectional views of the cartridge of FIG. 1, in respective planes that are perpendicular to one another;

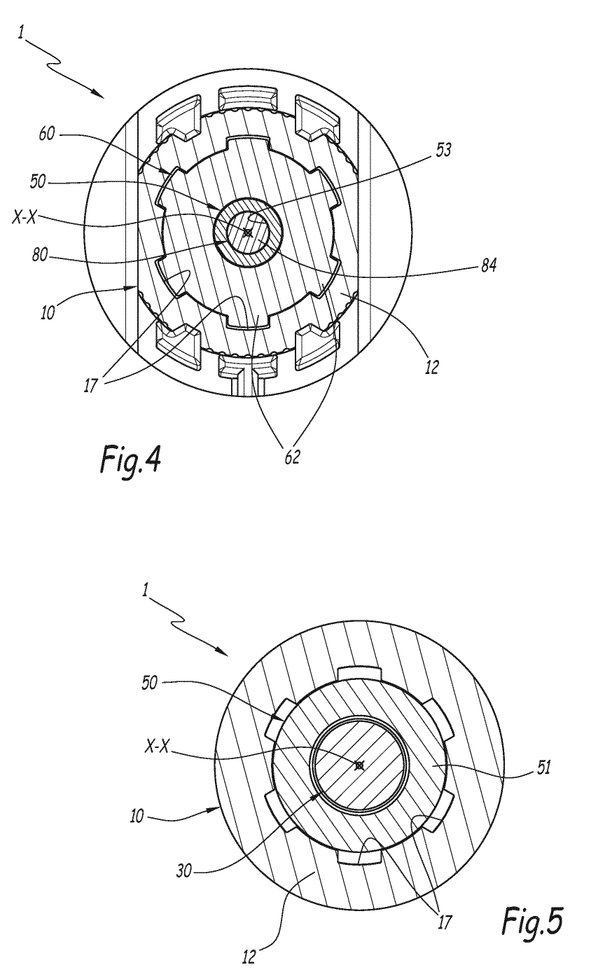

FIGS. 4 and 5 are sectional views along lines IV-IV and V-V, respectively, of FIG. 2; and

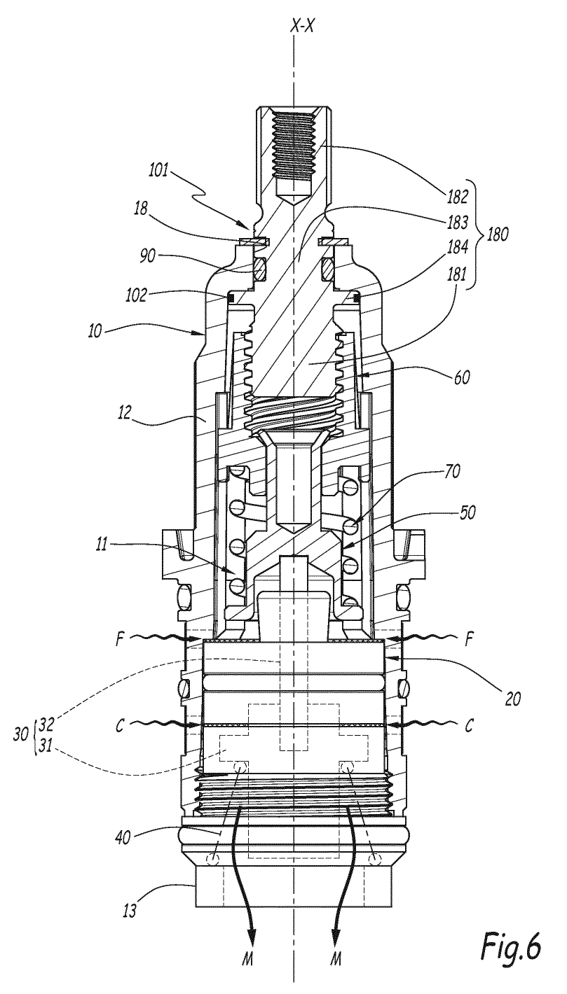

FIG. 6 is a view similar to FIG. 2, illustrating a second embodiment of a thermostatic cartridge according to the invention.

FIGS. 1 to 5 show a thermostatic cartridge 1, for example intended to equip a household valve fitting, such as a sink or shower faucet.

As clearly shown in FIGS. 1 to 5, cartridge 1 includes, as primary external component, a hollow casing 10, for example made from plastic. This casing 10 has a tubular overall shape, extending lengthwise around an axis X-X. The inner volume of the casing 10 forms a chamber 11, which is centered on the axis X-X and which extends, along said axis, between the opposite axial ends of the casing 10.

For convenience, the continuation of the description is oriented relative to the casing 10, in the direction where the terms “inner” and “outer” are understood relative to the chamber 11. Likewise, the terms “top” and “upper” refer to a direction oriented, along the axis X-X, toward one of the longitudinal ends of the casing 10, i.e., the end oriented toward the top part of FIGS. 2 and 3, while the terms “bottom” and “lower” designate an opposite direction.

Thus, between the top and bottom ends of the casing 10, the chamber 11 is delimited by the inner face of a tubular wall 12 of the casing 10, centered on the axis X-X.

In the example embodiment considered here, the casing 10 includes, at its lower end, a bushing 13, which is fixedly secured, for example by screwing, to the rest of the casing 10, extending the latter downward. This bushing 13 thus constitutes the lower end part of the tubular wall 12. Furthermore, in the example considered in the figures, the rest of the casing 10 is in a single piece, with the understanding that, in an alternative that is not shown, said casing can be made up of several parts fixedly secured to one another, by any appropriate means, in the same way that the bushing 13 is fixedly secured to the rest of the casing 10. Of course, in an alternative that is not shown, the bushing 13 may be provided in a single piece with all or part of the rest of the casing 10.

In the assembled configuration of the cartridge 1, as shown in the figures, the casing 10 may be mounted sealably inside a hollow body of a faucet, not shown in the figures, with radial insertion of sealing gaskets between the outer face of the casing 10 and the inner face of the aforementioned body.

The cartridge 1 makes it possible to set the temperature of mixed water M leaving said cartridge and obtained by mixing incoming hot water C and incoming cold water F. To do this, as explained gradually below, the cartridge 1 includes a slide valve 20, a thermostatic element 30 and a return spring 40, as well as a mechanism for adjusting the axial position of the thermostatic element 30, said mechanism including an end piece 50, a nut 60, an overtravel spring 70 and a screw 80. All of the aforementioned components 20, 30, 40, 50, 60, 70 and 80 are at least partially arranged in the chamber 11.

As shown in FIGS. 2 and 3, the slide valve 20 is mounted movably, in particular in translation substantially along the axis X-X, inside the chamber 11 between two opposite extreme positions, in which the slide valve respectively closes off the inlet for hot water C into the chamber 11 and the inlet for cold water F into the chamber 11. In the two aforementioned extreme positions, one and respectively the other of the opposite axial ends of the slide valve 20 are pressed against corresponding seats, respectively delimited by the casing 10, in particular by inner shoulders of said casing. To reach the seat associated with the hot water C, the latter radially crosses through the casing 10, which to that end delimits one or several peripheral apertures 14 through which the hot water C enters the chamber 11 and which are indicated in dotted lines in FIG. 2. Likewise, to reach the seat associated with the cold water F, the latter radially crosses through the casing 11, which to that end delimits one or several peripheral apertures 15 through which the cold water F enters the chamber 11 and which are indicated in dotted lines in FIG. 2. In the assembled state of the cartridge 1 and when said cartridge is mounted in a faucet, the apertures 14 and 15 are respectively supplied with hot water and cold water from outside the casing 1, typically through passages delimited by the body of the aforementioned faucet.

Depending on the position of the slide valve 20 relative to the casing 10, between the two aforementioned extreme positions, the quantities of hot water C and cold water F entering the chamber 11 are set and their mixing in the chamber forms the mixed water M, which leaves the chamber through an orifice 16 delimited to that end by the casing 10, at the lower end of the latter, as indicated schematically in FIG. 2.

The position of the slide valve 20 in the chamber 11 is commanded by the thermostatic element 30. To that end, the thermostatic element 30 includes a first heat-sensitive part 31, which is arranged in the chamber 11 such that the mixed water M flows around said part 31, and which is connected to the slide valve 20 at least in translation parallel to the axis X-X. In practice, the slide valve 20 can be secured fixedly to the part 31 of the thermostatic element 30, through any appropriate means, for example by screwing. The thermostatic element 30 also includes a second part 32 that is translatable substantially along the axis X-X relative to the first part 31. The first part 31 is provided, during heating, to actuate the separation of the part 32 with respect to the part 31: the part 31 thus acts on the lower end of the part 32, by moving the latter upward relative to the part 31. The practical embodiment of the thermostatic element 30 is not limiting with respect to the invention, said thermostatic element also only being indicated schematically in FIG. 2. According to one practical embodiment, the part 31 contains a thermodilatable material which, under the action of the heat from the mixed water M flowing along the part 31, expands and causes the relative separation of the part 32. One alternative embodiment is to provide the thermostatic element 30 in the form of an actuator with shape memory alloy.

Irrespective of the embodiment of the thermostatic element 30, the return spring 40 tends to return the parts 31 and 32 toward one another, in particular during the cooling of the part 31. To that end, in a manner known in itself and as indicated purely schematically in FIG. 2, the return spring 40 is interposed axially between the casing 10 and the thermostatic element 30.

As clearly shown in FIGS. 2 and 3, the upper end of the part 32 of the thermostatic element 30 is pressed axially against the end piece 50, this bearing resulting from the action of the return spring 40. It will be understood that the end piece 50 commands the axial position of the part 32 of the thermostatic element, in other words the altitude of said part 32 relative to the casing 10.

The end piece 50 is mounted in the chamber 11 movably along the axis X-X. As clearly shown in FIGS. 2, 3 and 5, said end piece is advantageously provided with a flange ring 51, which, in the considered example embodiment, is situated at the lower end of the end piece 50 and which extends radially protruding from the rest of the end piece so as to be received, with radial play, in the tubular wall 12 of the casing 10. By limiting the aforementioned radial play to the obtainment of the axial mobility of the end piece 50 in the chamber 11, the flange ring 51 is advantageously guided relative to the casing 10 by sliding contact with the latter, so as to align the end piece 50 on the axis X-X. The interest of this guiding of the end piece 50 will appear a bit later.

Furthermore, the end piece 50 forms, if applicable at its flange ring 51, downward axial bearing for the overtravel spring 70 while the latter bears axially upward against the nut 60. In other words, the overtravel spring 70 is inserted axially between the end piece 50 and the nut 60. The overtravel spring 70 has a great enough stiffness that, in the assembled state of the cartridge 1, it axially connects the end piece 50 and the nut 60 to one another rigidly as long as the axial movement of the slide valve 20 by the part 31 of the thermostatic element 30 relative to the casing 10 is free. In other words, as long as the slide valve 20 is movable downward without interfering axially with the casing 10, in particular without abutting axially against the seat associated with the hot water C, the end piece 50 and the nut 60 form, under the action of the overtravel spring 70, a rigid subassembly, in particular regarding the axial position of said subassembly relative to the casing 10. Conversely, once the downward movement of the slide valve 20 is prevented, typically by axial interference with the casing 10, the overtravel spring 70 is provided to deform under the effect of the upward movement, actuated by the part 31, the part 32 and the thermostatic element 30: by deformation of the overtravel spring 70, the end piece 50 can then translate upward, without altering the axial position of the nut 60. One thus avoids damage of the cartridge 1 during significant heating of the thermostatic element 30, leading to the deployment of the part 32 over an overtravel compared to the maximum travel of the slide valve 20 between its two extreme positions with respect to the fixed seats of the casing 10, respectively associated with the hot water C and the cold water F.

According to an arrangement whose interest will appear later, the end piece 50 and the nut 60 are adjusted radially to one another when the overtravel spring 70 axially connects the endpiece and the nut to one another rigidly. To that end, in the example embodiment considered in the figures, the end piece 50 delimits, advantageously at its upper end, a frustoconical surface 52, flared upward and turned toward the nut 60. At the same time, the nut delimits, advantageously at its lower end, a frustoconical surface 61, advantageously flared upward and provided to be pressed against the frustoconical surface 52 of the end piece 50, as shown in FIGS. 2 and 3: when the overtravel spring 70 axially connects the end piece 50 and the nut 60 to one another rigidly, these frustoconical surfaces 52 and 61 are pressed against one another under the action of the overtravel spring 70, thus radially adjusting the end piece and the nut to one another by centering on the respective geometric axes of the frustoconical surfaces 52 and 61, then combined with one another. This radial adjustment cooperation between the frustoconical surfaces 52 and 61 is reversible, in that these frustoconical surfaces disengage from one another when the overtravel spring 70 is deformed, in order to allow the relative upward movement of the end piece 50 relative to the nut 60.

As shown in FIGS. 2 to 4, the nut 60 is mounted in the chamber 11 so as both to be movable in axial translation relative to the casing 10 and connected in rotation around the axis X-X to said casing. To that end, in the example embodiment considered here, the face of the nut 60, turned toward the inner face of the tubular wall 12 of the casing 10, is provided with elongate ribs 62, which extend parallel to the axis X-X and which are received in a complementary manner in notches 17 delimited by the inner face of the tubular wall 12: by shape cooperation between the ribs 62 and the notches 17, the nut 60 is movable exclusively in translation inside the chamber 11. Advantageously, the radial play between said ribs 62 and said notches 17 is provided to be small enough that the cooperation between them guides the nut 60 relative to the casing 10 so as to align said nut on the axis X-X.

In the assembled state of the cartridge 1, the screw 80 is mounted screwed, around the axis X-X, in the nut 60, the screw 80 extending, along the axis X-X, from the inside of the chamber 11 to the outside of the casing 10. The screw 80 thus includes a threaded part 81, which, in the assembled state of the cartridge 1, is arranged inside the chamber 11 and is received screwed in the nut 60. In practice, the screwing-unscrewing cooperation between the nut 60 and the threaded part 81 of the screw is relatively loose to allow the screw to be rotated flexibly, while avoiding any risk of seizing at the interface between its threaded part 81 and the nut 60. In this context, the nut 60 may be made from plastic, which accentuates the functional play between its inner tapping and the threaded part 81 of the screw.

The screw 80 also includes an upper end part 82, which is arranged outside the casing 10 and which is provided to be connected in rotation to a maneuvering handle, not shown in the figures: to that end, said end part 82 is for example cannulated, as shown in FIGS. 1 to 3. Furthermore, the screw 80 is locked in axial translation relative to the casing 10, by any appropriate means, not limiting with respect to the invention. Thus, in the assembled state of the cartridge 1, when the screw 80 is rotated on itself around the axis X-X from outside the casing 10, in particular by urging the aforementioned maneuvering handle, the screw 80 drives the nut 60 in axial translation, downward or upward depending on the rotational driving direction of the screw 80. The translation of the nut causes the corresponding translational driving of the end piece 50, and thus of the part 32 of the thermostatic element 30, relative to the casing 10.

As shown in FIGS. 2 and 3, the screw 80 includes, axially between its threaded part 81 and its upper end part 82, a part forming a screw seat 83 that, in the assembled state of the cartridge 1, is arranged in a bore 18 of the casing 10, located at the upper end of said casing. Said bore 18 axially connects the chamber 11 to the outside of the casing 10, thus allowing the screw 80 to extend from the inside of the chamber 11 to the outside of the casing 10 via said bore 18. The screw seat 83 of the screw 80 is received in the bore 18 such that, inside said bore 18, the screw seat 83 is guided relative to the casing 10 so as to align the screw 80 on the axis X-X. In the example considered in the figures, said guiding of the screw seat 83 is at least partially done by a gasket 90 radially inserted between the screw seat 83 and the wall of the bore 18. This gasket 90 is provided both to compensate radial play between the screw seat 83 and the wall of the bore 18, and to seal the chamber 11 relative to the outside of the casing 10.

As shown in FIGS. 2 to 4, the screw 80 also includes a part forming a screw seat 84, which is separate from the threaded part 81 and the screw seat 83 and which is arranged inside the chamber 11, while being arranged outside the bore 18. This screw seat 84 protrudes axially downward from the threaded part 81 of the screw 80: in other words, the part 81 is arranged axially between the screw seats 83 and 84. Inside the chamber 11, the screw seat 84 is guided relative to the casing 10 so as to align the screw 80 on the axis X-X, while being received in a housing 53 of the end piece 50: this housing 53 is provided radially adjusted to the screw seat 84 while leaving the relative mobility in axial translation free between said housing and the screw seat 84. Thus, in addition to the guiding done by the cooperation between the screw seat 83 and the wall of the bore 18, the screw 80 benefits from a second guiding done between the screw seat 84 and the housing 53 of the end piece 50, this second guiding being obtained easily by sliding adjustment between the screw seat 84 and the housing 53. Then, the amplitude of the clearance of the screw 80 relative to the axis X-X is greatly limited: when a stress is applied to the upper end part 82 of the screw 80 seeking to incline said screw relative to the axis X-X, in particular by tilting at its screw seat 83 inside the bore 18, this urging is transmitted by the screw seat 84 to the end piece 50 while the latter is rigidly connected to the nut 60 by the overtravel spring 70 and is radially adjusted to said nut by cooperation between the frustoconical surfaces 52 and 61. The rigid subassembly, formed by the end piece 50 and the nut 60, prevents the screw 80 from tilting by radial bearing, against the inner face of the tubular wall 12, of the nut and/or the end piece 50, particularly of the flange ring 51 of the latter.

FIG. 6 shows a thermostatic cartridge 101 whereof the components identical to those of the cartridge 1 bear the same numerical references. The cartridge 101 differs from the cartridge 1 by its screw 180.

More specifically, the screw 180 of the cartridge 101 has the same technical purpose as the screw 80 of the cartridge 1 and to that end includes a threaded part 181, an end part 182 and a first screw seat 183, which are respectively similar to the part 81, the part 82 and the screw seat 83 of the screw 80.

Furthermore, the screw 180 includes a screw seat 184, which is separate from the threaded part 181 and the screw seat 183 and which is different from the screw seat 84 of the screw 80. More specifically, as shown in FIG. 6, the screw seat 184 is, inside the chamber 11, guided relative to the casing 10 so as to align the screw 180 on the axis X-X, by a gasket 102 inserted radially between the screw seat 184 and the tubular wall 12 of the casing 10: this gasket 102 is provided to compensate radial play between the screw seat 184 and the tubular wall 12. According to one practical and economical embodiment, the gasket 102 is an O-ring.

Compared to the cartridge 1, the guiding of the screw seat 184 of the screw 80, seeking to align the latter on the axis X-X, does not pass through the endpiece 50 and/or the nut 60, but is applied directly to the inner face of the tubular wall 12 by the gasket 102 attached specifically for that purpose.

According to one compact arrangement, which is implemented in the example embodiment of FIG. 6, the screw seat 184 is arranged axially between the threaded part 181 and the screw seat 183 of the screw 180.

Furthermore, like in the example of FIG. 6, the screw seat 184 is advantageously designed as a flange ring, protruding radially relative to the rest of the screw: this flange ring can then combine the alignment guiding function for the screw 180, as described above, and a blocking function of said screw in translation along the axis X-X relative to the casing 10, the flange ring to that end being pressed axially against a shoulder 19 of said casing, located at the junction between the chamber 11 and the bore 18. Furthermore, various arrangements and alternatives to the cartridges 1 and 101 described thus far may be considered.

1. A thermostatic cartridge, including:
a hollow casing, inwardly delimiting a chamber that defines an axis, inside which a cold fluid and a hot fluid enter, and from which a mixed fluid resulting from mixing of the cold and hot fluids exits,
a thermostatic element, arranged in the chamber and including both a first part, which is heat-sensitive and over which the mixed fluid flows, and a second part, which is movable in axial translation relative to the first part and which is moved by the first part so as to move away from the first part during heating of the first part,
a return spring, which is inserted axially between the casing and the thermostatic element so as to return the first and second parts of the thermostatic element toward one another,
a slide valve, which is mounted movably inside the chamber so as to set respective quantities of cold fluid and hot fluid entering the chamber, and which is connected in axial translation to the first part of the thermostatic element,
an end piece, which is arranged in the chamber and against which the second part of the thermostatic element is axially pressed the return spring,
a nut, which is mounted movable in axial translation inside the chamber, while being connected in rotation around the axis to the casing,
an overtravel spring, which is inserted axially between the end piece and the nut so as to connect the end piece and the nut axially and rigidly as long as axial movement of the slide valve by the first part of the thermostatic element relative to the casing is free, and to deform under axial movement of the second part of the thermostatic element by the first part of the thermostatic element when the axial movement of the slide valve by the first part of thermostatic element relative to the casing is prevented, and
a screw, which is mounted screwed around the axis in the nut, while being locked in axial translation relative to the casing, and which extends, along the axis, from the inside of the chamber to the outside of the casing via a bore of the casing, the screw including:
a threaded part, which is received screwed inside the nut,
a first screw seat, which is arranged in the bore and which, inside the bore, is guided relative to the casing so as to align the screw on the axis, and
a second screw seat, which is separate from the threaded part and the first screw seat and which is arranged inside the chamber, while being positioned outside the bore, said second screw seat being, inside the chamber, guided relative to the casing so as to align the screw on the axis.

2. The thermostatic cartridge according to claim 1, wherein the second screw seat of the screw is guided relative to the casing, so as to align the screw on the axis, while being received in a housing of the end piece such that the second screw seat of the screw is adjusted radially with respect to the housing while being movable in axial translation in the housing, and wherein the end piece and the nut are adjusted radially with respect to one another when the overtravel spring axially connects the end piece and the nut to one another rigidly.

3. The thermostatic cartridge according to claim 2, wherein the end piece and the nut are adjusted radially to one another by cooperation between frustoconical surfaces, which are respectively delimited by the end piece and the nut and which are flared axially away from the slide valve, these frustoconical surfaces being reversibly suitable for being pressed against one another under the action of the overtravel spring when the overtravel spring axially connects the end piece and the nut to one another rigidly, and for disengaging from one another when the overtravel spring is deformed.

4. The thermostatic cartridge according to claim 2, wherein the threaded part of the screw is positioned axially between the first screw seat and the second screw seat of the screw.

5. The thermostatic cartridge according to claims 2, wherein the end piece is provided with a flange ring that is guided relative to the casing so as to align the end piece on the axis, while being received, with radial play, in a tubular wall of the casing, said wall being centered on the axis and delimiting the chamber.

6. The thermostatic cartridge according to claim 1, the second screw seat of the screw is guided relative to the casing, so as to align the screw on the axis, by a gasket that compensates a radial play between the second screw seat of the screw and a tubular wall of the casing, said wall being centered on the axis and delimiting the chamber.

7. The thermostatic cartridge according to claim 6, wherein the second screw seat of the screw is positioned axially between the first screw seat and the threaded part of the screw.

8. The thermostatic cartridge according to claim 6, wherein the second screw seat of the screw is designed as a flange ring which is pressed axially against a shoulder of the casing, located at a junction between the chamber and the bore.

9. The thermostatic cartridge according to claim 6, wherein the gasket associated with the second screw seat is an O-ring.

10. The thermostatic cartridge according to claim 1, wherein the first screw seat of the screw is guided relative to the casing, so as to align the screw on the axis, by a gasket that simultaneously compensates a radial play between the first screw seat of the screw and a tubular wall of the bore, and seals the chamber relative to the outside of the casing.

11. The thermostatic cartridge according to claim 5, wherein the threaded part of the screw is positioned axially between the first screw seat and the second screw seat of the screw.

12. The thermostatic cartridge according to claim 8, wherein the second screw seat of the screw is positioned axially between the first screw seat and the threaded part of the screw.

13. The thermostatic cartridge according to claim 2, wherein the first screw seat of the screw is guided relative to the casing, so as to align the screw on the axis, by a gasket that simultaneously compensates a radial play between the first screw seat of the screw and a tubular wall of the bore, and seals the chamber relative to the outside of the casing.

14. The thermostatic cartridge according to claim 7, wherein the first screw seat of the screw is guided relative to the casing, so as to align the screw on the axis, by a gasket that simultaneously compensates a radial play between the first screw seat of the screw and a tubular wall of the bore, and seals the chamber relative to the outside of the casing.
